(19) United States
(12) Patent Application Publication
(10) Pub. No.: US 2016/0097627 A1
(43) Pub. Date: Apr. 7, 2016

(54) Speed Stud and joist Setting jig

(71) Applicant: Clyde Douglas Miller, Copperas Cove, TX (US)

(72) Inventor: Clyde Douglas Miller, Copperas Cove, TX (US)

(21) Appl. No.: 14/472,369

(22) Filed: Oct. 3, 2014

(51) Int. Cl. G01B 5/14; E04B 1/18

(52) U.S. Cl. CPC G01B 5/14; E04B 1/18

(57) ABSTRACT

The existing problem within the construction industry is that with each builder the framework for the project will differ based on the location of the supporting framework at the required distance, sometimes causing huge cost overages or poor quality workmanship. The solution to this problem is to ensure each ensuing supporting frame member (wood or metal 2×4, 2×6) is spaced exactly at the same distance as the previous frame member. This hand portable jig will ensure this occurs by setting the jig to the desired distance, then placing the jig where it straddles the last frame member installed, awaiting the insertion of the next frame member. Each newly installed frame member will be spaced at the same corresponding distance throughout the project. The Speed Stud and joist Setting Jig is my invention; it is unique because once the tool has been set to the desired distance one individual can consistently place wall studs or floor, ceiling joist into position and secure them into position. Other distinct features of this tool is it comes fully assembled and the tool is lightweight with only two moving parts section the inside receiver and the detent stop lock button. This small portable tool is designed to consistently space wall studs floor and ceiling joist in there correct position in accordance with building codes used in the framing of most commercial and noncommercial building utilizing wood or metal studs or joists of any dimension.

### FIELD OF THE INVENTION

Construction, measurements, insuring exact distance is maintained in the placement of wall studs and floor joists in residential and commercial construction.

### BACKGROUND OF THE INVENTION

In residential home construction the industry guidelines calls for all wall studs to be placed at a specific distance in relation to each other. The tools used to calculate this distance is the common tape measure, ruler, or construction square. One of the disadvantages with these tools is that each individual using one of these tools will use them in a different fashion. Some individuals will simply place the next stud or floor joist within proximity of the mandated location and some will simply miss-read the tape measure or measuring device. Over the course of the project this missteps will have a huge impact on the amount of time and materials needed to complete the project.

### OBJECT OF THE INVENTION

The advantages of the Speed stud and joist setting jig over the common industry tools such as the tape measure, construction square or ruler are.
a. The speed stud and joist setting tool only requires one hand to set it in into position. With a tape measure you would need someone on the other end to hold it in place.
b. The speed stud and joist setting jig, when set to the required setting will remain constant, throughout the use of the tool until the setting is changed.
c. Once the desired spacing is set there is no need to second guess what the distance is between each stud or floor joist.
d. The diameter of the material being used is preset in the construction of each jig which allows the user to move more quickly during the installation process.
e. Using the tool one individual can now install wall studs, and floor joists precisely, and quickly, this is not the case with a tape measure or construction square, both of which require additional time to ensure they are set correctly.
f. The tool is lightweight, durable and highly visible through its paint scheme.

### STATEMENT OF INVENTION

The inventive features of this of this tool as opposed to the tape measure or the construction square or even the ruler are found in the following features.
1. Hand portable collapsible and extendable preset measuring jig.
2. The stud cradle which allows the user to place one end of the tool's cradle on the current installed wall stud, and simple slid the next stud into the opposing cradle where the tool will stay in place allowing the builder to nail the next stud into position.
3. The outside and inside receivers these two parts are measured in such a fashion that they will take into account the thickness of the material being used and because the inside receiver is movable within the outside receiver several positional alignments can be incorporated in one tool. Allowing the user to set the tool for a 24, 18, 16 inch on center spacing down to a 12 inch on center spacing.
4. The sturdy detent push button spring will hold the tool securely at which ever setting the user desires, ensuring that each stud or floor joist is placed at the exact same distance as the proceeding stud or joist.
5. Finally the ability to use the tool as a supporting brace for those times when you need a third hand to hold a peace of lumber in position while securing it. This is something neither the tape measure nor the construction square can perform.

### SUMMARY OF INVENTION

The purpose of this invention is to make the standardized placement of wall studs and floor joist quick and error free in the consistency of their placement, with the minimal amount of individuals for the task.

### BRIEF DISCRIPTION OF DRAWINGS

The speed Stud and Joist Setting Jig is composed of five major parts the stud cradle (item A) detent button holes (item B) outside receiver (item C) inside receiver (item D) and the detent spring with button (item E). The detent button is placed inside of the inside receiver which protrudes through the holes drilled in the inside receiver and aligns with the holes drilled into the outside receiver at precise predetermined measurements. The stud cradles on both the inside receive and the outside receiver hold the tool into position as well as establish the correct distance as required by building code.

### DETAILED DESCRIPTION OF THE INVENTION

A method of ensuring all wall studs and floor joist in both residential and commercial construction maintain a consistent separation,

The speed stud and joist setting jig was created by me Clyde Douglas Miller as a way to consistently place the wall studs of homes on 16 inch centers. This is normally accomplished utilizing a tape measure, but over time this method is not consistent and it is very time consuming, so I created this small tool to make setting wall suds or floor or ceiling joist on 16 inch centers or 12 inch centers quick and concise every time.

The Speed Stud and Joist Setting Jig is composed of two parts which allow the tool to expand to a maximum length of 14 ⅝inches and contract to a length of 10 ⅝ inches

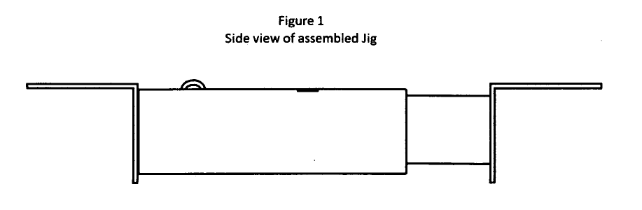

FIG. 1 depicts a side view of the Speed Stud and Joist Setting Jig.

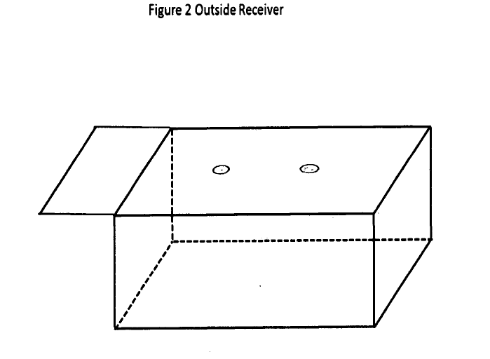

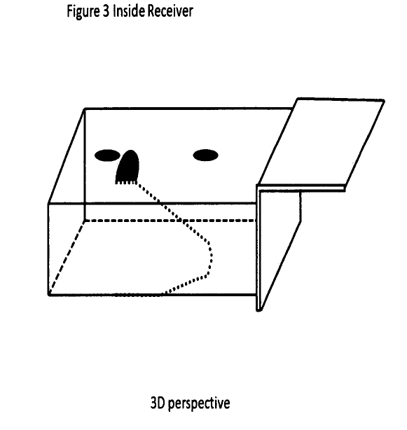

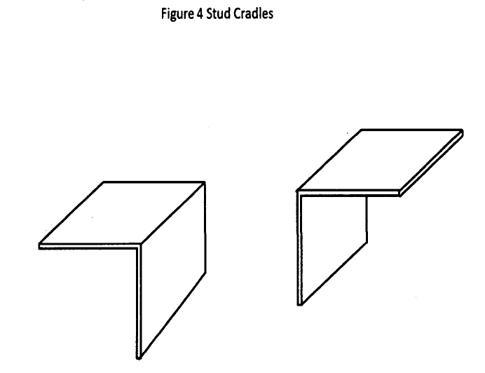

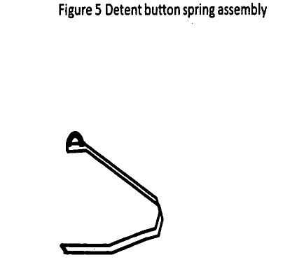

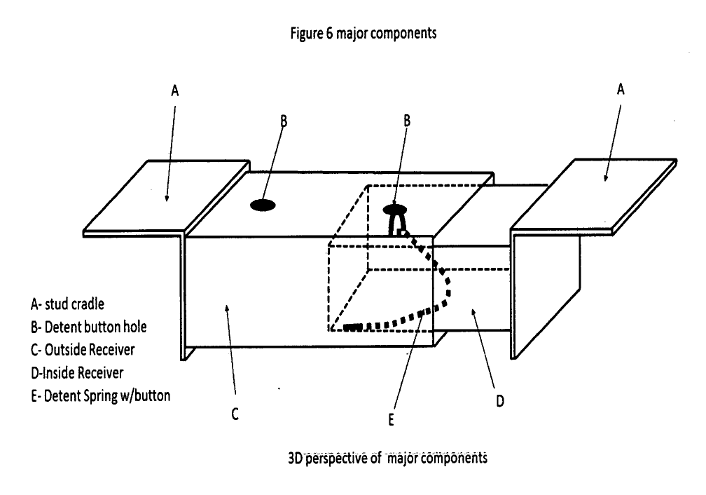

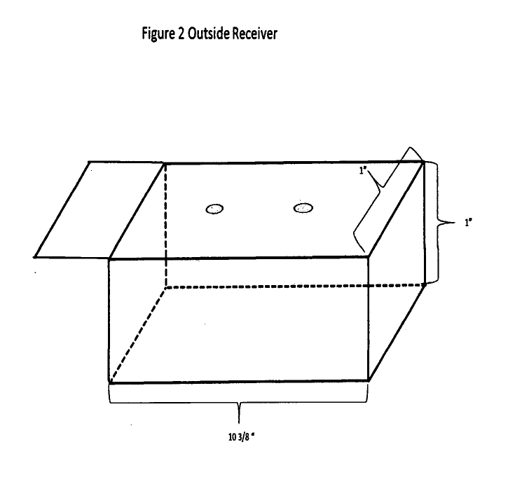

FIG. 2 item C shows the outside receiver of the Speed Stud and Joist Setting Jig with stop lock detent holes item B and the stud cradle item A.

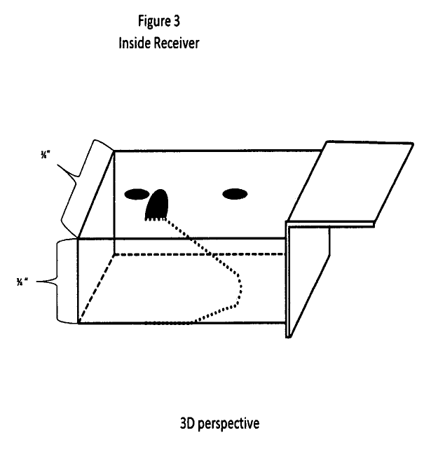

FIG. 3 depicts the inside receiver item D of the Speed Stud and Joist Setting Jig with stop lock detent spring item E.

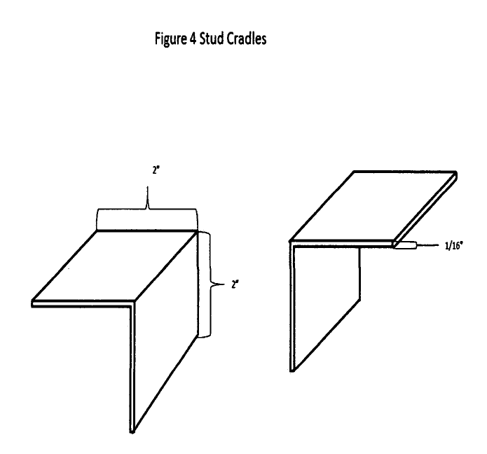

FIG. 4 depicts the fully assembled Speed stud and joist setting jig, with item D inserted into item C and the placement of item E the stop lock detent spring.

The “Speed Stud and joist Setting Jig” as seen in FIG. 1 is a hand tool constructed of 1 inch and ¾ in aluminum or steel consisting of two expandable and retracting parts as seen in FIGS. 2 and 3, both of which have a 90 degree angle bracket (stud cradle) welded to each end of the tool.

A. I claim independent claim: A hand portable construction jig apparatus comprising of two retracting and extending interlocking receivers used to ensure the precise placement of building materials in the construction of walls, floors, ceiling or any construction technique which requires precise, repetitive measurements at specified points of attachment.

B. Description: The speed stud and joist setting jig when collapsed is 10 & ½ inches long as measured from the insides of the stud cradle, and when extended is 14 & ⅝ inches in length. The jig consists of four major parts the outside receiver, the inside receiver and the stop lock detent button and the stud cradles. The outside receiver is 2 inches by 2 inches in diameter and 10 inches long. The inside receiver is ¾ inch by ¾ inches in diameter and is 10 1/8 inches in length. The inside receiver also contains the stop lock detent button which protrudes through the holes.

C. I claim Dependent claim comprising of an outside receiver with a stud cradle welded to the end of the outside cradle which also comprises of several holes drilled at the precise measurements required for the different setting of the jig at 12 inches on center and 16 inches on center.

D. I claim Also dependent claim comprising of an inside receiver which also has a stud cradle attached to the end of the receiver leaving the open end of the receiver open for the insertion of the detent spring/button.

E. I claim the Process claim: A method of constructing walls, floors, ceilings that require the supporting framework to be placed at consistent repetitive measurements on center at 12 inches and 16 inches throughout the construction process, to ensure subsequent other products to be installed correctly and on center.

F. Apparatus Claim: a device which will allow for the precise consistent placement of materials at a specified distance that requires only one individual for operation. A device which is hand portable, light weight and collapsible. A device which will hold material in position at a specified distance until the material can be fastened in the correct position.
